(19) United States
(12) Patent Application Publication
(10) Pub. No.: US 2018/0045238 A1
(43) Pub. Date: Feb. 15, 2018

(54) FASTENING ELEMENT AND METHOD

(71) Applicant: Hilti Aktiengesellschaft, Schaan (LI)

(72) Inventor: Thomas FOSER, Balzers (LI)

(21) Appl. No.: 15/553,252

(22) PCT Filed: Feb. 24, 2016
(86) PCT No.: PCT/EP2016/053844

§ 371 Date: Aug. 24, 2017

(30) Foreign Application Priority Data
Mar. 2, 2015 (EP) 15157172.6

(51) Int. Cl. F16B 25/00; F16B 5/02; F16B 35/00

(52) U.S. Cl. CPC F16B 25/0021; F16B 25/0042; F16B 35/005; F16B 5/0275

(57) ABSTRACT

The invention relates to a fastening element, comprising an insertion segment for inserting into a bore, having a self-tapping threaded segment having an external thread for screwing and tapping into the bore on a fastening object, and comprising a mounting segment for arranging outside of the bore, having an interface geometry for applying a torque to the fastening wherein it should be possible to fix a fixing part to the fastening element in a simple manner. This aim is achieved in that the mounting segment is additionally provided with a fixing device for indirectly or directly, in particular interlockingly and/or frictionally, fixing a fixing part on the mounting

The present invention relates to a fastening element, a method for manufacturing a fastening element as well as a method for fastening a fastening element.

Fastening elements are used for fastening fixation parts, for example, a grating onto an object for fastening, for example, a substrate of a floor of a vessel made of steel. To do so, a bore is cut into the substrate using a drilling device and then the fastening element is screwed into the bore. The bore here has a smaller diameter than the external diameter of the external thread of a threaded section of a fastening element. The external thread of the fastening element screws and cuts or therefore taps an internal thread on the bore into the object for fastening thereby fastening the fastening element in the bore.

When fastening elements are fastened on the walls having a small thickness of vessels, only a blind hole can be cut into such a wall as a bore with a small bore length in the range of 2 mm to 8 mm. Furthermore, it is necessary after fastening the fastening element in the bore to affix a fixation part on the fastening element.

In addition, the fastening element has a conically tapering tip without a thread on the forward end and a thread lead-in of the external thread of the threaded section with an increasing external diameter. Because of the threadless tip and the section of the external thread of the threaded section with the increasing diameter, only a portion of the threaded section with a constant and maximum diameter can make a significant contribution toward fastening the fastening element in the bore in the object for fastening. The threadless tip tapering conically and the thread lead-in with an increasing diameter are designed in the direction of a longitudinal axis of the fastening element from a forward end to a rear end and result in only a portion of the bore length being usable for fastening the fastening element.

Self-tapping threads are usually produced using a thread rolling method. According to the DIN 7500 standard, the axial length of the thread lead-in amounts to at least 1.5 times and at most 4 times the thread pitch. A shorter thread lead-in would be exposed to such great loads that, on the one hand, it could be destroyed in the course of tapping a single thread. On the other hand, abrupt changes in diameter cannot readily be produced by rolling. With known screws having an external diameter of the thread of less than approx. 10 mm, the axial length of the thread lead-in is therefore also greater than double the thread pitch.

The object of the present invention is to make available a fastening element, which can be fastened in a bore with a comparatively small bore length combined with a comparatively large holding force.

This object is achieved with a fastening element comprising an insertion section for insertion along a longitudinal axis into a bore on an object for fastening, with a self-tapping threaded section having a thread lead-in for tapping, preferably for cutting or shaping an internal thread into the bore and an external thread connecting to the thread lead-in along the longitudinal axis for screwing into the bore, preferably into the internal thread, wherein the external thread has an essentially constant external diameter, an essentially constant core diameter and an essentially constant thread pitch along the longitudinal axis, and wherein the thread lead-in has an increasing external diameter along the longitudinal axis, preferably increasing steadily, and said external diameter being larger in a usable range of the thread lead-in than the core diameter of the external thread. The fastening element additionally comprises a mounting section for arrangement outside of the bore and with an interface geometry for applying a torque to the fastening element. According to the invention, the length of the usable region of the thread lead-in along the longitudinal axis amounts to at most 1.3 times, preferably at most 1.2 times and especially preferably at most 1.15 times the thread pitch of the external thread.

Due to the shortening of the thread lead-in, the external thread which can thus withstand greater pullout forces is lengthened. This is advantageous in particular in the case of bores with a short bore length, for example, less than approx. 8 mm. The shortened thread lead-in is also exposed to greater loads during the tapping of the internal thread into the bore. However, this load does not result in destruction of the external thread in the case of a short bore length in particular.

According to an advantageous embodiment, the thread lead-in and/or the external thread has a coating. The coating preferably comprises a sliding coating, which reduces the friction between the thread lead-in and/or the external thread and the internal thread on the bore during the tapping and/or cutting of the bore. The coating also preferably comprises an adhesive coating, which increases the adhesion between the external thread and the internal thread on the bore to thereby reduce the risk of loosening of the fastening element out of the bore. The adhesive coating especially preferably comprises a reactive coating based on microencapsulated acrylates, the microcapsules of which are destroyed by compressive stress and/or shear stress during the tapping, so that the components thereby released become mixed and cure until hardened after the end of the tapping process.

According to one advantageous embodiment, the length of the usable range of the thread lead-in along the longitudinal axis amounts to at least 0.4 times, preferably at least 0.5 times the thread pitch of the external thread. Even with a short bore length, this ensures that the load on the thread lead-in is not so great that the external thread is destroyed when tapping the internal thread into the bore.

According to an advantageous embodiment, the height of the external thread is between 0.2 mm and 1.5 mm, preferably between 0.4 mm and 1.0 mm. On the one hand, the thread height of the external thread should not be too small, because otherwise the external thread is no tapped deeply enough into the bore and, on the other hand, it should not be too great because the external thread can otherwise be sheared off too easily. In both cases, anchoring in a bore with a comparatively short bore length of less than 8 mm, for example, would not have a sufficient pullout force under some circumstances.

According to an advantageous embodiment, the thread pitch amounts to between 0.5 mm and 2.0 mm, preferably between 0.6 mm and 1.3 mm. The thread pitch of the external thread should not be too small on the one hand, because otherwise the external thread would become too narrow and could easily sheared off while, on the other hand, it should not be too large because otherwise the surface of the bore is not adequately utilized under some circumstances. Here again, in both cases, anchoring in a bore with a comparatively short bore length of less than 8 mm, for example, would not result in an adequate pullout force under some circumstances.

According to an advantageous embodiment, the flank angle of the external thread is between 45° and 75°, preferably between 55° and 65°. The flank angle of the external thread should not be too small on the one hand, because otherwise the external thread would be too narrow and could be sheared off too easily and on the other hand, it should not be too large because otherwise the surface of the bore would not be adequately utilized under some circumstances or the external thread would not cut deeply enough into the bore. Here again in both cases an anchoring in a bore with a comparatively short bore length of less than 8 mm, for example, would not have an adequate pullout force under some circumstances.

According to an advantageous embodiment, the threaded section has an external diameter between 2 mm and 20 mm, preferably between 3 mm and 12 mm, especially preferably between 4 mm and 10 mm.

According to one advantageous embodiment, the threaded section, preferably the external thread, has an axial extent as the thread length in the direction of the longitudinal axis of the fastening element between 2 mm and 10 mm, preferably between 3 mm and 8 mm. The thread length of the threaded section is aimed in particular at the fact that the entire thread length can be arranged in the bore and a force can thereby be transferred to the object for fastening by the entire length of the thread of the fastening element.

According to one advantageous embodiment, the hardness of the material of the thread lead-in is at least 800 MPa, preferably at least 1,000 MPa. This ensures an adequate strength of the tip of the thread during the tapping of the internal thread into the bore. The thread lead-in and/or the external thread is preferably made of a hardened steel. The thread lead-in and/or the external thread is/are especially preferably made of a hardened steel, in particular an inductively hardened steel. It is also preferable for the tip of the thread to be made of a stainless material.

According to one advantageous embodiment, the fastening element has a sealing element preferably a sealing disk and/or a sealing ring, which seals the bore and/or the interspace and the fastening element with respect to the surroundings after the fastening element has been fastened on the object for fastening.

According to one advantageous embodiment, a fixation device is formed on the mounting section for fixation of the fixation part. The fixation part can therefore be fastened directly on the mounting section of the fastening element or indirectly by fastening an intermediate part to the fixation device and by the fact that the fixation part is or will be fastened onto the intermediate part. The fixation device is preferably designed on the basis of a corresponding geometry in particular, so that the fixation part or the intermediate part can be fastened in a form-fitting and/or force-locking manner on the mounting section of the fastening element.

The fixation device is preferably designed as an add-on external thread or internal thread or as a clip element or a catch element, and/or the fastening element is designed in the form of a rod or bolt. By means of the external thread or internal thread, the fixation part can be screwed onto the external thread or internal thread in a particularly simple manner. Then expediently of course the intermediate part can also be screwed onto the external thread or internal thread as the fixation device. In deviation from this, an annular groove in which the fixation part or the intermediate part can be secured by means of a, catch connection or clip connection may also be formed on the mounting section. The fastening element is preferably designed in the form of a rod or a bolt with a longitudinal axis, and the longitudinal axis is preferably a joint longitudinal axis for both the insertion section and the mounting section. The fixation device preferably has at least one means for exclusive form-fitting and/or force-locking fixation of the fixation part on the fastening element.

According to one advantageous embodiment, the interface geometry is designed to be coaxial and/or concentric and/or in point symmetry with the longitudinal axis of the fastening element and/or the interface geometry is designed as a recess or protrusion, preferably axial, on a rear end region of the fastening element or mounting section. In an embodiment as an axial recess, the interface geometry is designed, for example, as an internal polygon socket, preferably with rounded sides, especially preferably as an internal square socket or an internal hexagon socket or a round socket, and in an embodiment as a protrusion, the interface geometry is designed as an external polygon head, preferably as an external hexagon head or an external square head, for example. For turning the fastening element by means of the internal polygon or external polygon as the interface geometry, a torque can be applied to the fastening element, so that the external thread of the threaded section is screwed at the bore into the object for fastening and an internal thread is thereby cut into the bore at the insertion section by means of the external thread, and the fastening element is thereby screwed into the bore. The interface geometry also preferably comprises a slot drive, in particular preferably a cross-slot drive.

According to one advantageous embodiment, a forward end region of the insertion section is designed without a threadless tip and/or the external thread of the insertion section is designed essentially on the entire insertion section, in particular also on a forward end region of the insertion section, in particular apart from a transitional section to the mounting section. The fastening element does not have a threadless tip on the forward end region, so that the entire thread length of the external thread of the threaded section can advantageously be inserted for form-fitting fastening on the bore of the object for fastening. Thus, a high force can be transferred from the fastening element to the object for fastening with a short bore length even in the range of only 3 mm to 8 mm on the object for fastening.

According to an advantageous embodiment, an external diameter of the mounting section is larger, preferably at least 4% larger, than the external diameter of the threaded section. The external diameter of the mounting section is preferably the maximum diameter of the mounting section.

According to one advantageous embodiment, the fastening element or external thread is designed in one piece and/or of one or more preferably stainless and/or hardened and/or martensitic metals or alloys, in particular steels, for example, carbon steel and/or of ceramic and/or preferably sheathed plastic.

This object is also achieved by a method for manufacturing a fastening element in which an interface geometry is applied for creating a self-tapping threaded section on a semifinished product for applying a torque to the fastening element and a self-tapping thread, such that the self-tapping thread extends along a longitudinal axis up to an end face of the semifinished product. According to the invention a bevel is created on an end face of the semifinished product in a separate step wherein the self-tapping thread and the bevel partially overlap to form a thread lead-in to the tapping, preferably cutting of an internal thread into a bore and an external thread connected to and extending along the longitudinal axis at the thread lead-in for tapping into the bore along the longitudinal axis. In this way the geometry of the thread lead-in, in particular the length of the thread lead-in along the longitudinal axis, can be adjusted accurately. In particular it is possible to adjust the length of the thread lead-in to a level of at most 1.3 times, preferably at most 1.2 times, especially preferably at most 1.15 times the thread pitch of the external thread.

According to one embodiment, the bevel is not created until after the self-tapping thread has been produced on the semifinished product. According to another advantageous embodiment, the self-tapping thread is created in the semifinished product only after the bevel has been created.

According to one advantageous embodiment, the bevel is created by a machining method, preferably with a milling process. Alternatively the bevel is created by a shaping process or a rolling process. According to another advantageous embodiment, the self-tapping thread is created by a rolling process. Alternatively the self-tapping thread is created, preferably being cut by a shaping method or a machining method.

According to one advantageous embodiment, an expansion angle of the bevel amounts between 60° and 150°, preferably between 70° and 120°. Under some circumstances, the bevel also allows facilitated insertion of the fastening element into the bore. The diameter of the bore here is greater than the core diameter of the external thread of the threaded section and is smaller than the external diameter of the external thread of the threaded section. The core diameter at the bevel is preferably essentially as large as the core diameter of the external thread at the threaded section, i.e., with a deviation of less than 10%. The core diameter of the bevel and the external thread are especially preferably exactly the same in size.

This object is also achieved in a method for fastening a fastening element on an object for fastening in which a bore is tapped without a thread into the object for fastening, the fastening element is screwed into the bore, so that an internal thread is formed by an external thread into the object for fastening at the bore, preferably being cut or tapped and thereby the fastening element is fastened onto the object for fastening, preferably in a form-fitting manner. According to the invention, the internal thread of the object for fastening and the external thread of the fastening element mesh with one another with a radial cut between 0.2 mm and 2 mm, preferably between 0.2 mm and 1 mm, especially preferably between 0.2 mm and 0.7 mm. The radial furrow should not be too small, on the one hand, because the external thread will otherwise be cut too deeply into the bore and, on the other hand, should not be too large because the external thread can otherwise be sheared off too easily. In both cases, anchoring in a bore with a comparatively small bore length of less than 8 mm, for example, would not have adequate pull-out force under some circumstances.

According to one advantageous embodiment, the external thread of the threaded section has a thread pitch between 0.5 mm and 2 mm, preferably between 0.6 mm and 1.2 mm. The thread pitch of the external thread should not be too small, on the one hand, because the external thread would otherwise be too narrow and could easily be sheared off and on the other hand, should not be too large because otherwise the surface of the bore would not be adequately utilized under some circumstances.

According to an advantageous embodiment, the bore is formed as a blind hole with a bore length between 3 mm and 12 mm, preferably between 3 mm and 9 mm, especially preferably less than 8 mm. The external thread of the fastening element with a thread length of immersion between 2 mm and 8 mm, preferably between 3 mm and 6 mm is also preferably screwed into the object for fastening. The bore length and/or the thread length of immersion should not be too small on the one hand, because otherwise the fastening element could not be anchored adequately and, on the other hand, should not be too large, so that the external thread or the thread lead-in does not undergo too much wear during the tapping of the internal thread into the bore during which the fastening quantity of the fastening element in the bore might suffer.

According to one advantageous embodiment, the bore, in particular the blind hole, is drilled with a drilling machine and a drill. A depth stop or a step drill is preferably used, so that the bore length of the bore is predetermined.

According to an advantageous embodiment, the fastening element is set in the bore, in particular the blind hole, using a preferably force-operated, especially preferably electrical screw device. A depth stop is preferably used on the screw device or a shoulder is provided on the fastening element, especially preferably peripherally so that the thread immersion length is predetermined. Use of a screw device, especially preferably one with electronic torque detection, which automatically shuts down on reaching a predetermined torque during the setting process, is also preferred.

According to an advantageous embodiment, the bore is cut into a wall of a vessel as an object for fastening. The bore is also preferably tapped into an object for fastening made of metal, in particular steel, cast iron, copper or aluminum.

According to an advantageous embodiment, a bore is cut with a diameter which is greater than the core diameter of the external thread of the threaded section of the fastening element and is smaller than the external diameter of the external thread of the threaded section of the fastening element.

According to one advantageous embodiment, after the fastening element has been fastened in the bore, a fixation part is fastened to a mounting section of the fastening element outside of the bore, preferably using a fixation device, wherein the fixation part is preferably a grating, a line or a rail. According to another advantageous embodiment, the fixation part is fastened directly or indirectly to the fastening element using the fixation device in a form-fitting and/or force-locking manner.

Exemplary embodiments of the invention are described in greater detail below with reference to the accompanying drawings, in which:

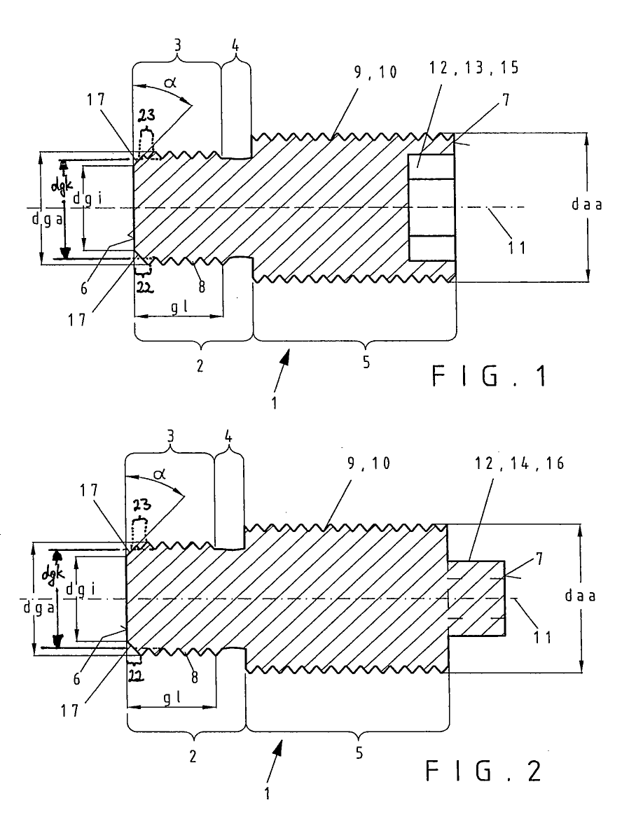

FIG. 1 shows a longitudinal section through a fastening element in a first exemplary embodiment,

FIG. 2 shows a longitudinal section through the fastening element in a second exemplary embodiment,

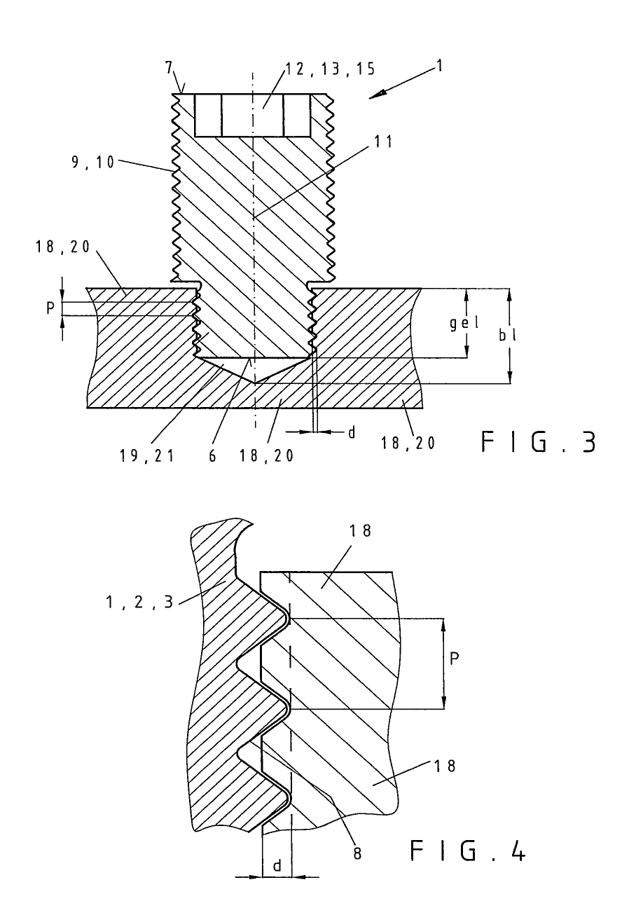

FIG. 3 shows a longitudinal section through the fastening element according to FIG. 1 in a bore in an object for fastening,

FIG. 4 shows a partial longitudinal section through an external thread of the fastening element in FIG. 3, which is screwed into the object for fastening,

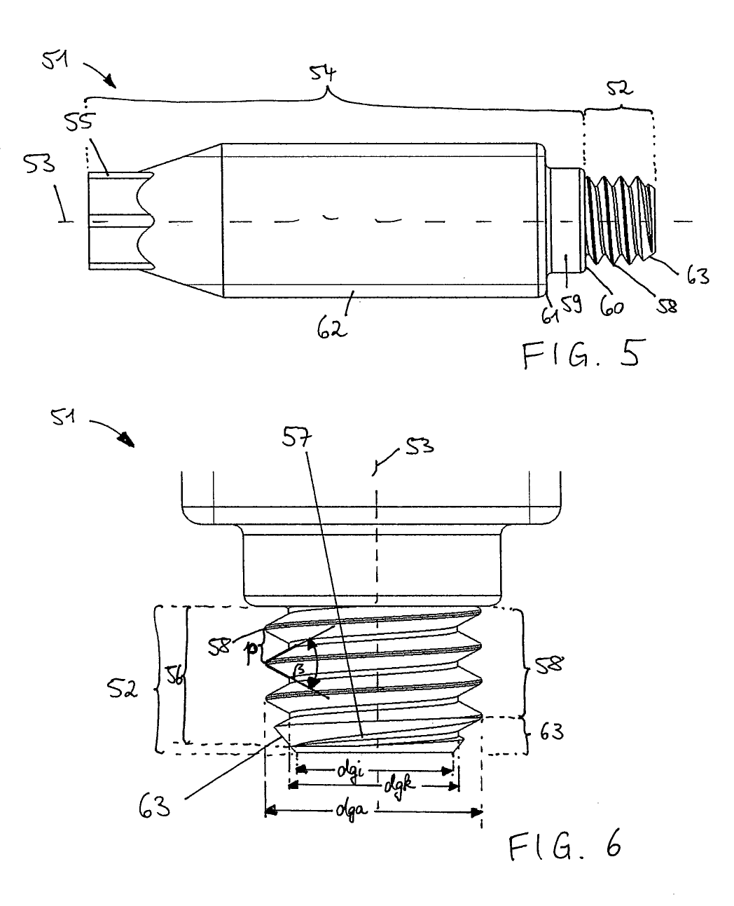

FIG. 5 shows a side view of a fastening element in a third exemplary embodiment, and

FIG. 6 shows a partial view of the fastening element according to FIG. 5.

FIG. 1 illustrates a first exemplary embodiment of a fastening element 1 made of steel in a longitudinal section. The one-piece fastening element 1 has an insertion section 2 and a mounting section 5. The insertion section 2 is used to insert the fastening element into a bore 19 on an object for fastening 18 (FIG. 3). The bore 19 is embodied as a blind hole 21. The insertion section 2 is subdivided into a threaded section 3 and a threadless transitional section 4, wherein the threaded section 3 comprises an external thread 8 and a thread lead-in 22. The transitional section 4 has an increasing diameter because it serves as the transition to the mounting section 5, and the mounting section 5 has a larger external diameter daa than the threaded section 3 with its external diameter dga. The threaded section 3 with the external diameter 8 on the insertion section 2 also has a core diameter dgk.

An add-on external thread 10 is formed on the mounting section 5 on the outside as a fixation device 9. The add-on external thread 10 as a fixation device 9 serves the purpose of direct and indirect fastening of a fixation part. The fixation part is a grating or a line or a rail, for example, and should be fastened to the fastening element 1. To do so, the fixation element may either be screwed directly onto the external thread 10 or an intermediate part is screwed onto the external thread 10 and then the fastening part is fastened to the intermediate part (not shown). The fastening part may also be placed over the external thread with a bore or the like and tightened securely with a nut as the intermediate part.

The fastening element 1 has a front end face 6 and a rear end face 7. A bevel 17 having a bevel angle α of 31°, for example, is formed on the threaded section 3 on the front end face 6 and/or on the front end area of the fastening element 1, i.e., the threaded section 3. For insertion of the fastening element 1 into the bore 19, the fastening element 1 can therefore be inserted more easily into the bore 19 because of the bevel 17. Furthermore, an interface geometry 12 for applying a torque to the fastening element 1 is formed on a rear end region of the fastening element 1. To this end, a recess 15 is cut on the mounting section 5 on the rear end face 7 and an internal hexagon 13 is formed on the recess 15. Therefore after insertion of a front end region of the fastening element 1 into the bore 19, a tool, for example, a hexagon insert bit wrench may be inserted into the internal hexagon 13 and a torque applied to the fastening element 1 and a compressive force applied forward to the fastening element 1 in the direction of the longitudinal axis 11, so that, in this way, an internal thread into the bore 19 of the blind hole 21 can be cut in a self-tapping manner on the object for fastening 18 by means of the thread lead-in 22 on the threaded section 3.

The thread lead-in 22 has an external diameter that increases steadily along the longitudinal axis 11. A usable range 23 of the thread lead-in 22 has an external diameter greater than the core diameter dgi of the external thread 8 because a region of the thread lead-in with a smaller external diameter, which may optionally be present, cannot be utilized for forming the thread. The length of the usable region 23 of the thread lead-in 22 along the longitudinal axis 11 is essentially half as large as the thread pitch p of the external thread 8.

FIG. 2 shows a second exemplary embodiment of the rod-shaped and bolt-shaped fastening element 1. In the following discussion, essentially only the differences in comparison with the first embodiment according to FIG. 1 will be described. The interface geometry 12 is embodied as a hexagon insert bit 14, as a protrusion 16 on the rear end region of the fastening element 1. To this end, the protrusion 16 is formed on the mounting section 5.

FIG. 3 shows the first exemplary embodiment of the fastening element 1 illustrated in FIG. 1, which is fastened in the bore 19. For fastening the fastening element 1 on the fastening element 18, i.e., a wall 20 of a vessel with a thickness of 4 mm to 8 mm, first the blind hole 21 is cut as a bore 19 with a bore length bl of 3 mm using a drill. Therefore, there remains a residual thickness of the wall 20 of 2 mm, for example, at the end of the blind hole 21. Next the insertion section 2 of the fastening element 1 is inserted into the bore 19 until the bevel 17 comes to rest on the blind hole 21 and/or the border of the blind hole 21 formed by the object for fastening 18 because the external diameter dga of the threaded section 3 is identical to the external diameter of the bevel 17. The external diameter dga of the threaded section 3 is greater than the diameter of the bore 19. Next, a torque is applied to the fastening element 1 by means of the internal hexagon socket, and a compressive force is applied in the direction of the longitudinal axis 11 in a self-tapping manner from the thread lead-in 22 and/or its usable region 23 on the threaded section 3 into the bore 19.

After screwing the fastening element 1 completely into the bore 19, there is a thread immersion length gel of 3 mm. The thread pitch p of the external thread 8 also amounts to 1.0 mm. The thread length gl of the external thread 8 is slightly larger than the thread immersion length gel. The furrow d cut object for fastening to the external thread 8 of the threaded section 3 amounts to 0.5 mm in the object for fastening 18. Because of the furrow d of 0.5 mm, secure fastening of the fastening element 1 on the object for fastening 18 is possible and nevertheless only a low torque is required for turning the fastening element 1 when cutting the internal thread into the bore 19 manually when tapping the internal thread into the bore 19. The thread pitch p of 1.0 mm with an external diameter dga of the threaded section 3 of 3 mm ensures a secure and reliable form-fitting fastening of the fastening element 1 in the bore 19.

When considered as a whole, important advantages are associated with the inventive fastening element 1. Because of the fixation device 9 on the mounting section 5, fixation parts can be fastened on the fastening element 1 particularly easily because the mounting section 5 is arranged outside of the bore 19 after being fastened onto the bore 19 and is therefore readily accessible. The insertion section 2 does not have a threadless tip so that in this way essentially the entire external thread of the threaded section 3 can serve the purpose of form-fitting fastening inside of the bore 19, and the bore 19 is utilized completely for form-fitting fastening of the fastening element 1 in the region having a constant diameter of the bore 19.

FIGS. 5 and 6 illustrate another exemplary embodiment of a fastening element 51 each shown in a side view drawn to scale. The bolt-shaped fastening element 51 comprises an insertion section 52 for insertion along a longitudinal axis 53 into a bore on an object for fastening (not shown) and a mounting section 54 for arrangement outside of the bore and with an interface geometry 55 formed as a round hexagon socket for applying a torque to the fastening element 1. The insertion section 52 has a self-tapping threaded section 56 with a thread lead-in 57 for cutting, in particular tapping an internal thread into the bore and an external thread 58 connected to the thread lead-in 57 along the longitudinal axis 53 for being screwed into the internal thread. The external thread 58 has a constant external diameter dga of 5.7 mm along the longitudinal axis 53, a constant core diameter dgk of 3.96 mm, a constant thread height h of 0.87 mm, where h=0.5 (dga−dgk), a constant flank angle β of 60° and a constant thread pitch p of 1.0 mm. The thread lead-in 57 has an increasing external diameter along the longitudinal axis 53 which increases steadily from a value equal to the core diameter dgk of the external thread 58 up to a value equal to the external diameter dga of the external thread 58. The external thread is thus continuously connected to the thread lead-in 57. The length of the usable region of the thread lead-in 57 along the longitudinal axis 53 amounts to 1.13 mm, i.e., it is 1.13 times the thread pitch p of the external thread 58.

The thread lead-in 57 and the external thread 58 have a non-friction coating which reduces the friction between the thread lead-in 57 and/or the external thread 58 and the internal thread on the bore during the tapping and screwing. In addition, the external thread 58 has an adhesive coating, which increases the adhesion between the external thread 58 and the internal thread on the bore after the end of the screwing process in order to thereby reduce the risk of loosening of the fastening element 51 out of the bore.

The threaded section 56 has a thread length of 2.5 mm in the direction of the longitudinal axis 53. The one-piece fastening element 51 and thus also the external thread 58 are made of an inductively hardened stainless steel with a material hardness of 1,000 MPa.

The mounting section 54 has a collar 59 on which a sealing element can be arranged which seals the bore and/or the interspace between the bore and the fastening element with respect to the surroundings after the fastening element has been fastened onto the object for fastening. For secure sealing, the collar 59 has a stop 60 which comes to a stop against the edge of the bore when the fastening element 51 is screwed in and thereby secures the depth of penetration so that the sealing element is clamped in a defined manner between a peripheral shoulder 61 on the mounting section 54 and the object for fastening.

The mounting section 54 additionally has a fixation device 62 for fixation of a fixation part (not shown). The fixation device 54 is designed as an add-on external thread with an external diameter of 8 mm by means of which the fixation part can be screwed into the fastening element 51.

To produce the fastening element 51, the interface geometry 55 is applied to a semifinished product by a shaping method and a self-tapping thread is applied to a semifinished product with a rolling method to create the threaded section 56. Then a bevel 63 is created on the front end face of the semifinished product by a milling process wherein the self-tapping thread and the bevel 63 overlap one another to form the thread lead-in 57 and the external thread 58.

The bevel angle of the bevel 63 amounts to 52.5°. Under some circumstances, the bevel also permits facilitated insertion of the fastening element into the bore. The diameter of the bore is greater than the core diameter dgk of the external thread 58 and smaller than the external diameter dga of the external thread 58. The internal diameter dgi of the bevel amounts to 3.5 mm at its start.

The internal thread shaped by the thread lead-in 57 in the bore of the object for fastening and the external thread 58 mesh with one another with a radial cut of 0.4 mm. The bore here is preferably embodied as a blind hole with a bore length of 5.7 mm, for example. The external thread 58 is then screwed into the object for fastening with a thread immersion length of 4 mm, for example. The thread immersion length here is determined by the stop 60.

This invention has been described on the basis of the exemplary embodiment as a fastening element for a grating, a line or a rail. However, it should be pointed out that the inventive fastening element is also suitable for other purposes. Furthermore, all the features of the various exemplary embodiments can be combined with one another in any form.

1. A fastening element comprising
an insertion section for insertion along a longitudinal axis into a bore on an object for fastening, the fastening element having a self-tapping threaded section with a thread lead-in for tapping an internal thread into the bore and an external thread connected to the thread lead-in along the longitudinal axis for screwing the fastening element into the bore,
wherein the external thread has a constant external diameter (dga), a constant core diameter (dgk) and a constant thread pitch (p) along the longitudinal axis,
wherein the thread lead-in has a usable region and an increasing external diameter along the longitudinal axis,
a mounting section for arrangement outside of the bore, the mounting section having an interface geometry for applying a torque to the fastening element, wherein
the usable region of the thread lead-in has a length along the longitudinal axis that is at most 1.3 times the constant thread pitch (p) of the external thread.

2. The fastening element according to claim 1,
the length of the usable region of the thread lead-in along the longitudinal axis is at most 1.2 times the constant thread pitch (p) of the external thread.

3. The fastening element according to claim 1, wherein
the length of the usable region of the thread lead-in along the longitudinal axis is at least 0.4 the constant thread pitch (p) of the external thread.

4. The fastening element according to claim 1, wherein
the external thread has a thread height (h) of between 0.2 mm and 1.5 mm.

5. The fastening element according to claim 1,
the constant thread pitch (p) is between 0.5 mm and 2 mm.

6. The fastening element according to claim 1, wherein
of the external thread has a flank angle of between 45° and 75°.

7. The fastening element according to claim 1,
the threaded section has a constant external diameter (dga) between 2 mm and 20 mm and/or the threaded section has an axial extent as a thread length (gl) in the direction of a longitudinal axis of the fastening element between 3 mm and 10 mm.

8. The fastening element according to claim 1, wherein
the thread lead-in has a hardness of material of at least 800 MPa.

9. The fastening element according to claim 1, wherein
the external thread is made of a hardened steel.

10. The fastening element according to claim 1, further comprising a
fixation device comprising an add-on external thread, or an internal thread or a clip element or a catch element.

11. A method for manufacturing a fastening element comprising:
a) making available a semifinished product having a longitudinal axis,
b) mounting an interface geometry on the semifinished product, for applying a torque to the fastening element,
c) applying a thread to create a self-tapping thread in the semifinished product, wherein the self-tapping thread extends along the longitudinal axis up to one end face of the semifinished product,
d) creating a bevel on the end face of the semifinished product separately from c), wherein the bevel is created for forming a thread lead-in for tapping an internal thread into a bore
wherein the self-tapping thread and the bevel and an external thread connected to the thread lead-in along the longitudinal axis for tapping a thread into the bore overlap at least partially along the longitudinal axis.

12. The method according to claim 11,
d) is carried out after c).

13. The method according to claim 11,
c) is carried out after d).

14. A method for fastening the fastening element according to claim 1, onto an object for fastening comprising:
creating a bore into the object for fastening,
screwing the fastening element into the bore, so that an internal thread is cut from the external thread on the fastening element into the object for fastening at the bore and the fastening element is fastened onto the object for fastening, the method including meshing
the internal thread of the object for fastening with the external thread of the fastening element with a radial furrow (d) between 0.2 mm and 2 mm.

15. The method according to claim 14, including forming
the bore as a blind hole with a bore length (bl) between 3 mm and 12 mm, and/or screwing the external thread of the fastening element with a thread immersion length (gel) between 2 mm and 8 mm into the object for fastening.

16. The fastening element of claim 1, wherein the increasing external diameter along the longitudinal axis of the thread lead-in is larger than the useable region of thread lead-in than a core diameter (dgk) of the external thread.

17. The fastening element of claim 2, wherein the length of the usable region of the thread lead-in along the longitudinal axis is a most 1.15 times the constant thread pitch (p) of the external thread.

18. The fastening element of claim 3, wherein the length of the usable region of the thread lead-in along the longitudinal axis is at least 0.5 times the constant thread pitch (p) of the external thread.

19. The fastening element of claim 4, wherein the thread height (h) of the external thread is between 0.4 mm and 1.0 mm.

20. The fastening element of claim 5, wherein the constant thread pitch (p) is between 0.6 mm and 1.3 mm.
